(19) United States
(12) Patent Application Publication
(10) Pub. No.: US 2020/0245649 A1
(43) Pub. Date: Aug. 6, 2020

(54) PLANT BASED VEGAN PROTEIN DRINK ENRICHED WITH REAL FRUIT JUICE

(71) Applicant: Halewood Laboratories Pvt. Ltd., Ahmedabad (IN)

(72) Inventor: Krutin Kaushik CHATURVEDI, Mumbai (IN)

(21) Appl. No.: 16/781,124

(22) Filed: Feb. 4, 2020

Related U.S. Application Data
(60) Provisional application No. 62/800,847, filed on Feb. 4, 2019.

(51) Int. Cl. A23L 2/66; A23L 2/02; A23L 2/68; A23L 2/60; A23L 33/00; A23L 33/15; A23L 33/16; A23L 33/12; A23J 1/14; A23J 1/12

(52) U.S. Cl. CPC A23L 2/66; A23L 2/02; A23L 2/68; A23L 2/60; A23L 33/40; A23V 2002/00; A23L 33/16; A23L 33/12; A23J 1/14; A23J 1/12; A23L 33/15

(57) ABSTRACT

The present invention discloses plant based vegan protein drink, which is a combination of pulse protein (faba bean protein), rice protein and pea proteins, enriched with real fruit juices, vitamins and minerals. Particularly, the protein drink of the present invention is free of non-GMO protein, lactose, animal protein, gluten, allergen and has reduced fat content and cholesterol that gives complete nutritional value and works as a complete meal replacement. The protein Drink of the present invention which is rich in Amino acids also has improved digestibility.

### CROSS REFERENCE TO RELATED APPLICATIONS

This application claims priority and herein incorporates by reference U.S. provisional patent application 62/800,847, filed Feb. 4, 2019.

### FIELD OF INVENTION

The present invention relates to a plant based vegan protein drink, which is a unique combination of pulse protein (faba bean protein), rice protein and pea proteins enriched with real fruit juices, vitamins and minerals. Particularly, the protein drink of the present invention is free of non-GMO protein, lactose, animal protein, gluten, allergen and has reduced fat content and cholesterol that gives complete nutritional value and works as a complete meal replacement. The protein drink of the present invention which is rich in amino acids also has improved digestibility.

### BACKGROUND OF THE INVENTION

Proteins are biological amino acids which are found in all cells of the human. Proteins in the human organism perform a variety of functions such as they act as antibodies to the defence of infections, used for the production of muscles, used to manufacture hormones, enzymes, cellular messengers, nucleic acids, and immune-system components. Without adequate protein, our bodies cannot put together the structures that make up every cell, tissue, and organ, nor can it generate the biochemical substances needed for cardiovascular function, muscle contraction, growth, and healing. Overtraining of muscles could lead to injury and hence muscles require adequate supplement of protein to heal up quickly.

A variety of protein drinks are currently available in the market and are consumed for variety of purposes, ranging from assisting in weight loss to supporting muscle growth to enhancing general athletic performance. A section of the consumers purchase the protein drink with no specific purpose in mind or have no knowledge of the purpose of the protein drink which they consume. Most of the protein drinks are formulated with certain purposes so as to benefit the consumer.

Majority of health drinks are animal or milk based drinks. The major problem with high intake of animal or milk based drinks is increased risk of cardiovascular diseases. The other major disadvantage is most of the animal or milk based drinks is their allergenic nature. Moreover, milk based drinks are not suitable to people who are lactose intolerant.

The protein drink of vegetable or plant based appeals to all vegan, vegetarian and non-vegetarian consumers. The protein drinks of vegetable origin reduce the levels of saturated fats and cholesterol causes less side effects, are as effective as whey protein in helping one build muscle, gain strength and recover from exercise. However, the currently marketed vegetable or plant based protein drinks do not fulfil the nutritional requirements and the digestibility issues.

US20080206430 discloses a vegetarian nutritional supplement comprising a blend of soy protein, rice protein and pea protein. The nutritional supplement is provided in US '430 to have effective relative digestibility comparable to whey and flavour and texture comparable to isolated soy protein. However, the said nutritional supplement does not fulfil the requirements of vitamins, minerals, carbohydrates required by the human body. Moreover, many reports suggest that the soy protein causes hormonal imbalances in men depriving testosterone and promoting the production of oestrogen, produces abnormal enlargement of mammary gland in men, can also alleviate hot flashes in some menopausal women. Further, soy contains isoflavones which act like estrogen in the body. Since many breast cancers need estrogen to grow, consumption of soy protein could increase breast cancer risk in certain women.

US20120128832 relates to Organic Vegan Protein sports drinks and shakes formulated from 100% organic and natural plant-based ingredients with protein, vitamins, minerals and other nutrients. The Organic plant proteins used in the drinks and shakes are predominantly, Organic Hemp Powder, Organic Pea Powder and Organic Vegan powder (made from a mixture of Organic seed sprouts) Organic Soy milk and Organic Almond milk.

A need still exists in the art to provide vegetable or plant based protein drink which is highly nutritious and contains essential amino acids, carbohydrates, essential vitamins and minerals required by the human body with easy digestibility such that the drink is a complete food in itself and can be given as a meal replacement. The other objective is to provide protein drink which is favourable to all types of consumers which is rich in amino acids, contains Fruit juice, vitamins and minerals.

### SUMMARY OF THE INVENTION

In accordance with the above, the present invention provides plant based protein drink enriched with real fruit juices which is free of lactose, animal protein, gluten and allergen, is free of non-GMO protein, has reduced fat content and which meets the requirement of the people who need full nourishing drink. The present plant based protein drink contains proteins, amino acids, carbohydrates and is formulated with additional vitamins and minerals such that the approx. 20% recommended daily allowance (RDA) of essential vitamins, minerals are fulfilled making it a highly nutritious complete food which may be considered as meal replacement. The plant based protein drink enriched with real fruit juices is rich in antioxidant that gives additional benefit of increased immunity to fight against infections.

In an aspect, the plant based (vegan) protein source for the said protein drink is selected from a combination of low fat content 25%-35% pulse protein (faba bean protein), 25%-35% rice protein or 40%-45% pea protein or mixture thereof. The combination of said proteins in the drink is 100% plant based allergen free and low in fat and cholesterol. The protein in the said drink delivers essential amino acids required by the body, is rich in dietary fibre, improves solubility of product, reduces bitterness and has improved absorption and digestibility. The right combination and blend of the protein from faba bean, rice and pea protein is the highlight of the product.

In another aspect, the 12% to 14% reconstituted real fruit juices are selected from fruits such as pomegranate, strawberry, oranges, Mixed Berries and other such fruits that activate the proteins in the body, increase the internal antioxidant activity and helps in removing the toxins from the cells.

In yet another aspect, the present plant based protein drink is fortified with vitamins and minerals, to meet the optimal daily nutritional requirements. The vitamins comprises fat soluble as well as water soluble vitamins such as vitamin A, vitamin B1 nitrate, vitamin B2, vitamin B3, vitamin B5, vitamin B6, vitamin B12, Folic acid, Vitamin D and the like. The minerals added comprise sodium, iron, manganese, copper, calcium, potassium, phosphorous and the like or its salts.

The additives in the plant based protein drink enriched with real fruit juices is selected from acidity regulators, non-nutritive natural high intensity sweeteners, optionally natural sugars, stabilizing agents, sequestering agent, buffering agent, flavouring agents and such like in suitable amounts.

Accordingly, the present invention provides plant based protein drink enriched with real fruit juice, comprising;
i. Plant protein in an amount of 3.0 to 5.8% w/v;
ii. 12% to 14% reconstituted Fruit juices in an amount of 2.0-4.0% w/v;
iii. Vitamins and mineral premix in an amount of 0.15 to 0.30% w/v;
iv. Additives in an amount of 5.5 to 7.5% w/v; and
v. water;
   wherein the said drink is free of lactose, gluten, preservative and allergen, free of non-GMO protein, has reduced fat content with easy digestibility and is 100% vegan.

In an aspect, the plant based proteins in the drink are in the form of concentrate/Isolate/Hydrolysate which consists of 20%-35% pulse protein (faba bean protein) or 25%-35% rice protein or 40%-45% pea protein or mixtures thereof.

The plant based protein drink enriched with real fruit juice of the present invention may optionally further contain Docosahexaenoic Acid (DHA) in an amount of 0.1 to 0.2% w/v.

In yet another aspect, the present invention provides plant based protein in the form of concentrate/Isolate/hydrolysate comprising 20%-35% by weight pulse-faba bean protein or 25%-35% by weight rice protein or 40%-45% by weight pea protein or mixtures thereof.

In yet another aspect, the plant based protein drink enriched with real fruit juices is prepared by the process steps comprising;

mixing plant based protein source in the form of concentrate/Isolate/Hydrolysate consisting of 20%-35% pulse protein (faba bean protein), 25%-35% rice protein or 40%-45% pea protein or in combination thereof with RO water followed by addition of 12% to 14% reconstituted fruit juice, vitamins and mineral premix, additives with RO water; and blending the above mix with pre-formulated sugar syrup and adding RO water;

standardizing the above mixture, filtering, sterilizing, homogenizing and packing in ready to drink tetra packs.

In another embodiment, during the process, about 1-2% of said plant based proteins consisting of 20%-35% pulse protein (faba bean protein) or 25%-35% rice protein or 40%-45% pea protein or in combination thereof are further mixed in step (i) to maintain the protein content in the range of 3.2 to 5.8% w/v in the finished product.

### DETAILED DESCRIPTION OF THE INVENTION

The invention will now be described in its various preferred as well as optional embodiments, so that the various aspects therein will be more clearly understood and appreciated.

The present invention discloses a nourishing drink which is plant based protein drink containing real fruit juices as one of the main ingredient. The plant based protein drink of the present invention not only contains proteins and amino acids but also contain Dietary Fibres, carbohydrates, 15 essential vitamins and minerals, Docosahexaenoic Acid (DHA) required by the human body thus making the present protein drink as meal replacement. The Drink is rich in Amino Acid Profile obtained from the unique combination of plant based (vegan) Proteins and improved digestibility.

The plant based protein drink enriched with real fruit juices of the present invention is free of lactose, animal protein, gluten and allergen, is free of non-GMO protein and has reduced fat content and which meets the nourishment requirement of all types of people.

### Source of Ingredients

The Pulse (Faba) Protein is a Faba bean protein concentrate sourced from USA/Europe. The Powder contains 55% to 60% protein content and the true protein digestibility is around 90%.

Rice Protein is basically a Rice Protein Hydrolysate. Rice protein is a co-product of the rice starch industry. Rice protein powder generally contains up to 80% proteins in dry matter. Rice protein contains no gluten and is non-allergenic. Its amino acid profile is similar to that of milk. The rice protein used in the present invention contains less than 0.05 ppm cadmium. The rice protein products are EU Approved. These products are mainly sourced from Europe, China. The relative Protein digestibility is more than 85%.

Pea protein is made by grinding dried peas into a fine powder. The starch and fibre are removed, leaving a powdered concentrated protein substance (aka pea protein isolate). These are further hydrolyzed so as to make it soluble and easily digestible. It is completely plant-based, unlike whey, casein, and egg-based protein powders, and therefore ideal for vegetarians and vegans. The pea protein is EU approved. These proteins are mainly sourced from Europe, China. The Relative Protein digestibility is 87%.

The 12% to 14% reconstituted Fruit juices used in the present invention are procured from Europe and China.

In an embodiment, the present invention discloses plant based protein drink enriched with real fruit juices comprising;
i. Plant protein in an amount of 3.0 to 5.8% w/v;
ii. 12% to 14% reconstituted Fruit juices in an amount of 2.0-4.0% w/v;
iii. Vitamins and mineral premix in an amount of 0.12 to 0.30% w/v;
iv. Additives in an amount of 5.5 to 7.5% w/v; and
v. water;
   wherein the said drink is free of lactose, gluten, preservative and allergen, free of non-GMO protein, has reduced fat content with easy digestibility and is 100% vegan.

The plant based protein drink enriched with real fruit juices of the present invention may optionally contain Docosahexaenoic Acid (DHA) in an amount ranging from 0.1 to 0.2% by weight of the composition.

The various plant based proteins in the drink are in solid form. The proteins are stable and have a shelf life of 12 months. The combination of said proteins in the drink is 100% plant based allergen free and low in fat and cholesterol. The proteins in the said drink delivers essential amino acids required by the body, is rich in dietary fibre, improves solubility of product, reduces bitterness and has improved absorption and is easily digestible.

The rice protein used as protein source in the drink is free of LDL cholesterol, free from Gluten and soy, is low in fat and carbohydrates and helps in leading healthy lifestyle as it has high amount of dietary fibre.

The nutritive profile of hydrolyzed plant protein (60% Rice+40% Pea protein) of the present invention is given in Table 1 below:

TABLE 1

| Nutritive Content | Amount |
|---|---|
| Carbohydrates | 3.9 g/100 g |
| Protein | 80 g/100 g |
| Fat | 0.9 g/100 g |
| Energy | 412 Kcal/100 g |

The plant protein used as protein source in the drink is a rich source of highly bio-available and easily accessible amino acids. It has 80% protein content, is in the form of hydrolysate which increases its solubility in water. The protein is hypoallergenic, is lactose and gluten free, is low in carbohydrates, is high in Branched chain Amino Acids (BCAAs) which helps the body in muscle building and decreases the stomach fat. Protein is also classified as an Intermediate-fast protein which means that once digested, protein is quickly assimilated by the body for protein synthesis. The protein digestibility is about 87%.

The nutritive profile of pulse (Faba bean) Protein of the present invention is given in Table 2 below.

TABLE 2

| Calories | 315 kcal/100 gm |
|---|---|
| Calories from fat | 33 kcal/100 gm |
| Total Fat | 3.7%(max) |
| Saturated Fat | 0.7%(max) |
| Trans Fatty Acids | 0% |
| Saturated Fat + Trans Fatty | 0.7% (max) |
| Acids | |
| Cholesterol | Not detected |
| Sodium | 10 mg/100 g |
| Total carbohydrates | 25.9% |
| Dietary Fibre | 13.4% |
| Sugars | 1.7% |
| Protein | 57.9% |
| Potassium | 2040 mg/100 g |
| Moisture* | Approx. 12% |
| Ash | 5.7% |

The amino acid distribution in said proteins of the present invention is provided in Table 3 below.

TABLE 3

| | | Pea + Rice | Pulse |
|---|---|---|---|
| | | Proteins % | proteins % |
| Sr. No. | Amino Acids | as g/100 g | as g/100 g |
| 1. | Alanine | 3.4 | 2.4 |
| 2. | Aspartic Acid | 8.5 | 6.3 |
| 3. | Cysteine | 1.6 | 0.6 |
| 4. | Glutamic Acid | 13.5 | 9.6 |
| 5. | Glycine | 2.9 | 2.4 |
| 6. | Proline | 3.3 | 2.5 |
| 7. | Serine | 3.9 | 1.9 |
| 8. | Tyrosine | 2.2 | 1.8 |
| 9. | Arginine | 6.6 | 5.6 |
| 10. | Histidine | 2.1 | 1.2 |
| 11. | Isoleucine | 3.8 | 2.6 |
| 12. | Leucine | 6.5 | 4.5 |
| 13. | Valine | 4.2 | 2.7 |
| 14. | Lysine | 6.0 | 3.8 |
| 15. | Methionine | 0.9 | 0.4 |
| 16. | Phenylalanine | 4.3 | 2.5 |
| 17. | Threonine | 2.8 | 2.0 |
| 18. | Tryptophan | 0.7 | 0.6 |

In a preferred embodiment, the present plant based protein drink contains natural fruit juice for supplementing the health benefits and developing the product that delight the senses. The fruit juices preferably used in the drink is selected from pomegranate, strawberry, oranges or mixed berries and other such fruits or combination thereof that activates the proteins in the body, increases the internal antioxidant activity and helps in removing the toxins from the cells.

The pomegranate juice contains anti-oxidants which helps in immunity and prevents infection. It contains Vitamin C, Vitamin E, Vitamin K, folates, Potassium. The anti-oxidants in pomegranate juice helps to remove free radicals protect cells from damage and reduce inflammation. It helps in digestion and also in heart disease.

The strawberry juice is loaded with anti-oxidants, vitamin C, vitamin K, potassium, folic acid, calcium, iodine, magnesium, manganese, potassium and healthy omega-3 fats and is rich in fibre. The strawberry juice is a great source of phytonutrients which help in preventing inflammatory diseases such as asthma and arthritis. The strawberry juice keeps the skin young and wrinkle free.

Orange Juice contains thiamine, riboflavin, niacin, vitamin B-6, folate, Pantothenic acid, phosphorus, magnesium, manganese, selenium and copper, calcium, and good source of carbohydrate. Because of their high vitamin C content (over twice the daily need) oranges are associated with boosting the immune system. Further, orange juice detoxifies the body, has anti-inflammatory properties, supports blood circulation and reduces high blood pressure.

Accordingly, the fruit juices are reconstituted fruit juices (12% to 14%) as per Food Safety and Standards Authority of India (FSSAI) standards which are added to the protein drink in an amount ranging from 2.0-4.0% w/v. The 12% to 14% reconstituted fruit juice have the BRIX value in the range of 7.0-70 Bx and is in the range of 12.5-14.5 Bx in the finished product.

In an embodiment, enriching the plant based protein drink with real fruit juices supplements easy digestion, improves immune system, prevents infection and helps in keeping the skin young and wrinkle free. The high level of vitamin C and fruit pectin in the juice helps to activate proteins in the body which helps increase the internal antioxidant production and also helps in removing toxins from the cells.

In another embodiment, the vitamins added to the plant based protein drink with real fruit juices comprises fat soluble as well as water soluble vitamins such as vitamin A, vitamin B1 nitrate, vitamin B2, vitamin B3, vitamin B5, vitamin B6, vitamin B12, Folic acid, Vitamin D and the like. The minerals added comprise sodium, iron, manganese, copper, calcium, potassium, phosphorous and the like or its salts. The plant based protein drink with real fruit juices further optionally contains Docosahexaenoic acid (DHA).

The additives used in the present plant based protein drink enriched with real fruit juices is selected from acidity regulators, sweetening agent, stabilizing agents, sequestering agent, buffering agent, colors, flavouring agents and such like.

The sweetening agents in the drink are selected from non-nutritive natural high intensity sweetener such as stevia, sucralose or monk fruit in an amount ranging from 0.2%-0.4% w/v. The use of non-nutritive natural high intensity sweetener in the present protein drink makes it more consumer friendly and can be consumed even by patients having high glycemic index without any adverse effects. The non-nutritive natural high intensity sweetener used though are much sweeter than sugar they provide fewer calories per gram than sugar because they are not completely absorbed by the human digestive system.

Further, the sweetening agent optionally may contain natural sugars in an amount ranging from 6.0 to 7.5% w/v.

The acidity regulators in the drink is selected from citric acid, malic acid, sodium citrate, potassium citrate and such like in an amount ranging from 0.1-0.4% w/v; preferably the acidity regulator is citric acid.

The emulsifying and/or stabilizing agent in the drink is selected from carrageenan, xanthan gum, alginates of various grades in an amount ranging from 0.01 to 0.04% w/v.

The buffering agent is selected from potassium dihydrogen phosphate and the like in an amount ranging from 0.05 to 0.2% w/v.

The suitable sequestering (chelating) agent selected from calcium carbonate added in an amount ranging from 0.01 to 0.1% w/v.

The flavouring agents are selected from strawberry, mixed berries or orange flavours in suitable amount.

In a preferred embodiment, the present invention discloses plant based protein drink enriched with pomegranate and strawberry juice, comprising;
i. Plant protein in an amount of 3.0 to 4.2% w/v;
ii. 12% reconstituted Pomegranate-Strawberry juice in an amount of 2.0 to 2.8% w/v;
iii. Vitamins and mineral premix in an amount of 0.12 to 0.16% w/v;
iv. Additives in an amount of 7.0 to 7.5% w/v; and
v. water;
   wherein the said drink is free of lactose, gluten, preservative and allergen, free of non-GMO protein, has reduced fat content with easy digestibility and is 100% vegan.

In yet another preferred embodiment, the present invention discloses plant based protein drink enriched with orange juice, comprising;
i. Plant protein in an amount of 3.0 to 4.2% w/v;
ii. 12% reconstituted Orange juice in an amount of 2.0 to 2.8% w/v;
iii. Vitamins and mineral premix in an amount of 0.12 to 0.16% w/v;
iv. Additives in an amount of 7.0 gm to 7.5% w/v; and
v. water;
   wherein the said drink is free of lactose, gluten, preservative and allergen, free of non-GMO protein, has reduced fat content with easy digestibility and is 100% vegan.

In an embodiment, the plant based proteins in the drink are in the form of concentrate/Isolate/Hydrolysate which consists of 20%-35% pulse protein (faba bean protein) or 25%-35% rice protein or 40%-45% pea protein or mixtures thereof.

The vitamins added to the plant based protein drink with real fruit juices such as combination of reconstituted pomegranate and strawberry concentrate or reconstituted orange juice concentrate comprises fat soluble as well as water soluble vitamins such as vitamin A, vitamin B1 nitrate, vitamin B2, vitamin B3, vitamin B5, vitamin B6, vitamin B12, Folic acid, Vitamin D and the like. The minerals added comprise sodium, iron, manganese, copper, calcium, potassium, phosphorous and the like or its salts. The plant based protein drink with real fruit juices optionally further contains Docosahexaenoic acid (DHA) in an amount of 0.1 to 0.2% w/v.

The additives in the plant based protein drink with real fruit juices such as combination of reconstituted pomegranate and strawberry concentrate or reconstituted orange juice concentrate are selected from acidity regulators, sweetening agent, stabilizing agents, sequestering agent, buffering agent, colors, flavouring agents and such like.

The sweetening agents in the drink are selected from non-nutritive natural high intensity sweetener such as stevia, sucralose or monk fruit in an amount ranging from 0.2 to 0.4% w/v. The use of non-nutritive natural high intensity sweetener in the present protein drink makes it more consumer friendly and can be consumed even by patients having high glycemic index without any adverse effects. The non-nutritive natural high intensity sweetener used though are much sweeter than sugar they provide fewer calories per gram than sugar because they are not completely absorbed by the human digestive system.

Further, the sweetening agent optionally may contain natural sugars in an amount ranging from 6.0 to 7.5% w/v.

The acidity regulators in the drink is selected from citric acid, malic acid, acetic acid, sodium citrate, potassium citrate and such like in an amount ranging from 0.1-0.4% w/v; preferably the acidity regulator is citric acid.

The emulsifying and/or stabilizing agent in the drink is selected from carrageenan, xanthan gum, alginates of various grades in an amount ranging from 0.01 to 0.04% w/v.

The buffering agent is selected from potassium dihydrogen phosphate and the like in an amount ranging from 0.05 to 0.2% w/v.

The suitable sequestering (chelating) agent selected from calcium carbonate added in an amount ranging from 0.01 to 0.1% by weight of the drink.

The flavouring agents are selected from strawberry, mixed berries or orange flavours in suitable amount.

In yet another embodiment, the present invention relate to plant based protein in the form of concentrate/Isolate/hydrolysate comprising 20%-35% by weight pulse-faba bean protein or 25%-35% rice protein by weight or 40%-45% by weight pea protein or mixtures thereof.

In an embodiment, the plant based protein in the form of concentrate/Isolate/hydrolysate comprising 20%-35% by weight pulse-faba bean protein or 25%-35% rice protein by weight or 40%-45% by weight pea protein or mixtures thereof of the present invention relates to a food product with high nutritional value and improved digestibility.

In another embodiment, the plant based protein of the present invention may be used together with real fruit juices as a complete meal replacement of high nutritional value.

In another embodiment, the present invention discloses a process for preparing plant based protein drink enriched with real fruit juice which comprises the steps of;
i. mixing the plant based protein source in the form of concentrate/Isolate/Hydrolysate consisting of 20%-35% pulse protein (faba bean protein) or 25%-35% rice protein or 40%-45% pea protein or mixtures thereof with RO water followed by addition of 12% to 14% reconstituted fruit juice, vitamins and mineral premix, additives with RO water; and blending the above mix with pre-formulated sugar syrup and adding RO water;
ii. standardizing the above mixture, filtering through 1-2 mm filter, sterilizing at 95±2° C. for 30-40 sec, homogenizing at 180 bar pressure and packing in ready to drink tetra packs.

In another embodiment, during the process, the plant based proteins of the present invention may degrade and to maintain the protein content to 3.2-5.8% in finished product, about 1.0-2.0% consisting of 20%-35% pulse protein (faba bean protein) or 25%-35% rice protein or 40%-45% pea protein or in combination thereof are further mixed in step (i) to achieve the desired protein content.

Docosahexaenoic Acid (DHA) in an amount ranging from 0.1 to 0.2% by weight of the composition may optionally further be added to step (i) during the process.

Accordingly, quality tested plant based protein consisting of 20%-35% pulse protein (faba bean protein) or 25%-35% rice protein or 40%-45% pea protein or combinations thereof were mixed. To the mixture 1.0-2.0% of plant based protein consisting of 20%-35% pulse protein (faba bean protein) or 25%-35% rice protein or 40%-45% pea protein or combinations thereof were further mixed and the mixture was added to 150-160 gm reverse osmosis (RO) water at temperature in the range of 40-50° C. The mixture was agitated for about 30 minutes to obtain homogenized mixture. The reconstituted real fruit juice of 12% to 14% by weight, premix of vitamins and minerals, optionally DHA and other additives in suitable proportion were admixed with the homogenized mixture in chilled RO water. The mixture was then blended with sweetening agent in syrupy form and RO water for about 20-30 mins at ambient temperature. A part of the blended mix was sent for quality control testing. RO water was further added, if required. The mixture was further standardized and the standardized product was sent for quality control testing. The standardized product was filtered using filtration membrane of about 1-2 mm thickness. The product was sterilized and packed aseptically in tetrapack.

The RO (Reverse Osmosis) water used in the present process is obtained after passing the water through multi-step purification process. The purification process comprises passing the water through multi-graded filters such as duplex strainers to remove large particles of dirt and debris, sterile filtration membranes of varying filter pore-sizes to remove particles or microorganisms that may affect the safety of the water, then subjected to cartridge filtration followed by treatment with activated carbon which adsorbs undesired chemicals and organic compounds. The water is then treated with chlorine, and the chlorinated water is further filtered and treated with activated charcoal. This is followed by UV radiation which at the certain wavelength causes bacteria to be sterilized and other micro organics to be broken down. The water is further dosed with citric acid, softeners and the purification processes are repeated until clean and purified potable RO water is obtained.

In an embodiment, the protein in the drink is derived from the plant based protein powder in the form of concentrate, isolate or hydrolysate containing combination of 20%-35% by weight of pulse protein (faba bean protein) or 25%-35% by weight of rice protein or 40%-45% by weight of pea protein.

From consumer's point of view the real fruit enriched plant based protein drink has a pH in the range of 4.25 to 5.0, BRIX of 12.5-14.5 Bx, acidity in the range of 0.20 to 0.30. The microbial content is as per FSSAI standards of not more than 50 CFU/ml of total plate count (TPC). The drink is free from pathogens.

The plant based protein drink of the present invention contains about 14.0-15.0 gm of carbohydrates obtained from the proteins, sucrose and the fruit juices of the composition.

The finished product of real fruit juice enriched plant based protein drink of the present invention is stable at 30° C. for a period of twelve months and has accelerated stability of 6 months at 40° C. and 75% humidity as shown in Tables 4 and 5 respectively.

In an embodiment, the present invention provides plant based protein drink enriched with real fruit juice which is free of caffeine, preservative, lactose, gluten and is low in fat content. The protein drink made from the blend of three plant proteins i.e. Rice protein, Pea protein and Faba protein are quick absorbing proteins and easy to digest. The protein drink is allergen free and 100% vegetarian. The drink can be given to teenagers, average adults who do workouts, sportsperson, and athletes, diet conscious persons, growing kids above 3 years of age, persons who are allergic to milk, animal protein and soy.

The plant based protein drink enriched with real fruit juice of the present invention with vitamins and minerals makes it a complete nutritional profile apart from providing energy, carbohydrates, amino acids so as to make the drink healthy with high nutritional value and provides a balanced diet. The addition of vitamins and minerals helps in giving complete nourishing drink and delivers approx. 20% recommended dietary allowance (RDA) of all essential vitamins and minerals. The drink serves as a complete replacement of meal for sports persons, diet conscious persons, teenagers, as milk replacement for growing kids except infants.

The unique benefit of the protein drink of the present invention is obtained by using the plant based proteins selected from pulse (faba) or pea or rice protein or mixtures thereof in right proportion. The unique combination of the proteins in the drink increases the immunity and decreases the chances of osteoporosis, lowers cardiac risk. The protein drink is a rich source of vitamin B complex. It helps in weight management since the product has right combination of plant based protein which is easy to absorb and can be easily digested without causing any damage to kidney.

Following examples are given by way of illustration therefore should not be construed to limit the scope of the invention.

### EXAMPLE 1

### Pomegranate and Strawberry Protein Drink (180 ml)—Reconstituted 12%

a) Composition:

| | Amount (gms) in | |
|---|---|---|
| Ingredients | 180 ml or(% w/v) | |
| Protein content derived from | (3.92%) 7.056 | gm |
| combination of Rice protein 30%, | | |
| Pea Protein40% and Pulse protein | | |
| (faba bean protein) 30% | | |
| 12% reconstituted pomegranate juice | (1.75%) 3.15 | gms |
| (65 Brix) | | |
| 12% reconstituted strawberry juice | (0.75%) 1.35 | gms |
| (7.0 to 10.0 Brix) | | |
| Sucrose | (6.8%) 12.24 | gms |
| Diluted Stevia Powder | (0.25%) 0.45 | gms |
| Citric acid | (0.2%) 0.36 | gms |
| Di potassium hydrogen phosphate | (0.1%) 0.18 | gms |
| Carageenan | (0.03%) 0.054 | gms |
| Vitamin and mineral premix | (0.15%) 0.27 | gms |
| Flavorants | (0.0166%) | 0.054 |
| Tocopherol | (0.0067%) | 0.01206 |
| Sodium chloride | (0.05%) | 0.09 |
| Water | (84.497%) | 152.095 |

b) Process:

Process parameters

| Process Temperature | 95 +/− 2° C. | |
|---|---|---|
| (sterilizing temperature) | | |
| Holding Time | 30 | sec |
| Strainer (filter) | 1 | mm |

| | |
|---|---|
| De- aerator | On line |
| Homogenizer | On line (at 180 bar |
| | pressure) |

7.056 gm of quality tested plant protein content in the form of concentrate/isolate/hydrolysate consisting of 30% pulse-faba bean protein, 30% rice protein and 40% pea protein were mixed. To the mixture was added 0.11 gm of plant based protein consisting combination of 30% pulse-faba bean protein, 30% rice protein and 40% pea protein and the mix was added to 152 gm of reverse osmosis (RO) water at temperature of 45±2° C. and the mixture was agitated for about 30 minutes to obtain homogenized mixture. This was followed by addition of 3.15 gms of reconstituted (12%) pomegranate and 1.35 gms of reconstituted (12%) strawberry fruit juice, 0.36 gms of citric acid, 0.18 gms of dipotassium hydrogen phosphate, 0.054 gms of carrageenan 0.27 gms of premix of vitamins and minerals, strawberry flavour, color were admixed with the homogenized mixture in RO water. 12.24 gms of sucrose as sugar syrup was added to the mixture. To achieve proper sweetness of drink 0.45 gms of diluted Stevia powder was added to the mixture and blended for 30 minutes. The final Brix, acidity and pH were checked and a part of the blended mix was sent for quality control testing. RO water was added, if required, for final standardization and the standardized product was sent for quality control testing. The standardized product was then filtered using filtration membrane of 1 mm thickness. The product was then homogenised and sterilized. The sterilized product was packed aseptically in tetra packs.

Nutritional Value per 100 ml:

| | | |
|---|---|---|
| Energy | 53.35 | kcal |
| Carbohydrate | 9.0 | gm |
| Sugar | 6.8 | gm |
| Protein | 3.92 | gm |
| Fat | 0.05 | gm |

Chemical Parameters in Finished Product

| | |
|---|---|
| BRIX | 13.55 ± 0.05 |
| pH | 4.6 ± 0.2 |
| Acidity | 0.26 ± 0.03 |

Microbiology

| | |
|---|---|
| Total Acid uric Count | <1 CFU/2 ml |
| Yeast and mold | <1 CFU/2 ml |

### EXAMPLE 2

### Pomegranate and Strawberry Protein Drink (180 ml)—Reconstituted Juice Content is 12%

a) Composition

| | Amount (gms) in | |
|---|---|---|
| Ingredients | 180 ml or (% w/v) | |
| Protein content derived from | 7.002 gm (3.89%) | |
| combination of Rice protein 30%, | | |
| Pea Protein40% and Pulse protein | | |
| (faba bean protein) 30% | | |
| 12% reconstituted Pomegranate and | (2.45%) | 4.41 |
| strawberry juice | | |
| Sucrose | (6.8%) | 12.24 |
| Citric acid | (0.2%) | 0.36 |
| Potassium di hydrogen phosphate | (0.1%) | 0.18 |
| Stabilizer | (0.03%) | 0.054 |
| Xanthan gum | | |
| Vitamin and mineral premix | (0.15%) | 0.27 |
| Flavorant | (0.015%) | 0.027 |
| Water | (86.2%) | 155.16 |

b) Process:

Process parameters

| Process Temperature | 95 ± 2° C. | |
|---|---|---|
| (sterilizing temperature) | | |
| Holding Time | 30 | sec |
| Strainer (filter) | 1 | mm |

| | |
|---|---|
| Deaerator | On line |
| Homogenizer | On line(at 180 bar |
| | pressure) |

7.002 gm quality tested protein content in the form of concentrate/isolate/hydrolysate consisting of 30% pulse-faba bean protein, 30% rice protein and 40% pea protein were mixed. To the mix was added 0.11 gm of plant based protein consisting combination of 30% pulse-faba bean protein, 30% rice protein and 40% pea protein and the mix was added to 152.09 gms (86.49%) of reverse osmosis (RO) water at temperature of 45±2° C. and the mixture was agitated for about 30 minutes to obtain homogenized mixture. This was followed by addition of 4.41 gms of reconstituted (12%) pomegranate and strawberry fruit juice, 0.36 gms of citric acid 0.18 gms of potassium dihydrogen phosphate, 0.054 gm of Xanthan gum (stabilizer), 0.27 gms of premix of vitamins and minerals, strawberry flavour were admixed with the homogenized mixture in RO water. 12.24 gm of sucrose as sugar Syrup was added to the mixture . . . and the mixture was blended for 30 minutes. The final Brix, acidity and pH were checked and a part of the blended mix was sent for quality control testing. RO water was added, if required, for final standardization and the standardized product was sent for quality control testing. The standardized product was then filtered using filtration membrane of 1 mm thickness. The product was then homogenised and sterilised. The sterilized product was packed aseptically in tetra packs.

Nutritional Values per 100 ml:

| | | |
|---|---|---|
| Energy | 53.35 | kcal |
| Carbohydrate | 9.0 | gm |
| Sugar | 6.8 | gm |
| Protein | 3.89 | gm |
| Fat | 0.05 | gm |

Chemical Parameters in Finished Product

| | |
|---|---|
| BRIX | 13.55 ± 0.05 |
| pH | 4.6 ± 0.2 |
| Acidity | 0.26 ± 0.03 |

Microbiology

| | |
|---|---|
| Total Aciduric Count | <1 CFU/2 ml |
| Yeast and mold | <1 CFU/2 ml |

### EXAMPLE 3

### Orange Juice Enriched Protein Drink (180 ml)—Reconstituted Juice Content is 12%

a) Composition:

| | Amount (gms) in | |
|---|---|---|
| Ingredients | 180 ml or(% w/v) | |
| Protein content derived from | (3.9%) | 7.02 |
| combination of Rice protein 30%, | | |
| Pea Protein40% and Pulse protein | | |
| (faba bean protein) 30% | | |
| 12% reconstituted Orange juice (65 brix) | (2.25%) | 4.05 |
| Sucrose | (6.8%) | 12.24 |
| Citric acid | (0.2%) | 0.36 |
| diPotassium hydrogen phosphate | (0.1%) | 0.18 |
| Stabilizer -carragenen | (0.03%) | 0.054 |
| Vitamin and mineral premix | (0.15%) | 0.27 |
| Stevia | (0.25%) | 0.45 |
| Flavorants | (0.0233%) | 0.042 |
| Tocopherol | (0.007%) | 0.01206 |
| Sodium chloride | (0.05%) | 0.09 |
| Sunset yellow | (0.002%) | 0.0036 |
| Water | (84.73%) | 152.514 |

b) Process:

Process parameters

| Process Temperature | 95 +/− 2° C. | |
|---|---|---|
| (sterilizing temperature) | | |
| Holding Time | 30 | sec |
| Strainer (filter) | 1 | mm |

| | |
|---|---|
| Deaerator | On line |
| Homogenizer | On line(at 180 bar |
| | pressure) |

7.02 gm of quality tested protein content in the form of concentrate/isolate/hydrolsilate consisting of rice protein and pea protein were mixed. To the mixture was added 0.085 gm of plant based protein consisting combination of 30% pulse-faba bean protein, 30% rice protein and 40% pea protein. The mixture was further added to 152.514 gms of reverse osmosis (RO) water at temperature of 45±2° C. and agitated for about 30 minutes to obtain the homogenized mixture. 4.05 gms of reconstituted orange fruit juice (12%), 0.36 gms of citric acid, 0.18 gms of potassium dihydrogen phosphate, 0.054 gms of caragenen, 0.027 gm of vitamins and mineral premix, orange flavour 0.01206 gm tocopherol, 0.09 gm sodium chloride, suitable color were admixed with the homogenized mixture in RO water. 12.24 gm of sucrose as sugar syrup was added to the mixture. The final Brix, acidity and pH were checked and a part of the blended mix was sent for quality control testing. RO water was added, if required, for final standardization and the standardized product was sent for quality control testing. The standardized product was then filtered using filtration membrane of 1 mm thickness. The product was then homogenised and sterilized. The sterilized product was packed aseptically in tetra packs.

Nutritional Values per 100 ml:

| | | |
|---|---|---|
| Energy | 53.53 | kcal |
| Carbohydrate | 9.2 | gm |
| Sugar | 6.8 | gm |
| Protein | 3.9 | gm |
| Fat | 0.05 | gm |

Chemical Parameters in Finished Product

| | |
|---|---|
| BRIX | 13.80 ± 0.05 |
| pH | 4.6 ± 0.2 |
| Acidity | 0.28 ± 0.05 |

Microbiology

| | |
|---|---|
| Total Aciduric Count | <1 cfu/ml |
| Yeast and mold | <1 cfu/ml |

### EXAMPLE 4

### Stability Data of Orange Juice Enriched Protein Drink (180 ml)—Reconstituted Juice Content is 12%

TABLE 4
Real time Stability data of Prorush- Orange
Volume: 180 ml
Mfg. Date: Jul. 12, 2017 Expiry Date: Aug. 11, 2018
Temperature: RT i.e. 30° C. Stability start on Date: Aug. 12, 2017

| | | | | | | | |
|---|---|---|---|---|---|---|---|
| Sr. | | | Result | Result | Result | Result | Result |
| No. | Parameters | Limit | (Initial) | (3 M) | (6 M) | (9 M) | (12 M) |

Analysis Date

| 1. | Description | Orange colored | | Complies | Complies | Complies | Complies | Complies |
|---|---|---|---|---|---|---|---|---|
| | | hazy liquid | | | | | | |
| 2. | pH | 4.6 ± 0.2 | | 4.68 | 4.65 | 4.64 | 4.63 | 4.63 |
| 3. | Degree Brix | 13.80 ± 0.05 | | 13.85 | 13.84 | 13.83 | 13.83 | 13.82 |
| 4. | Color | Orange color | | Complies | Complies | Complies | Complies | Complies |
| 5. | Odor | Typical Orange | | Complies | Complies | Complies | Complies | Complies |
| | | Flavor | | | | | | |
| 6. | Taste | Typical Orange | | Complies | Complies | Complies | Complies | Complies |
| 7. | Iron (As Fe) | 4.17 mg/100 ml | | 5.48 | 5.46 | 5.45 | 5.44 | 5.43 |
| 8. | Calcium (as Ca) | 166.67 mg/100 ml | | 166.11 | 166.08 | 166.07 | 166.07 | 166.06 |
| 9. | Protein | 3.88 gm/100 ml | | 3.92 | 3.91 | 3.90 | 3.89 | 3.88 |
| 10. | Energy | 53.53 kcal/100 ml | | 53.58 | 53.56 | 53.55 | 53.54 | 53.53 |
| 11. | Carbohydrates | 14.93 gm/100 ml | | 14.96 | 14.95 | 14.94 | 14.94 | 14.94 |
| 12. | Fat | 0.05/100 | ml | 0.0 | 0.0 | 0.0 | 0.0 | 0.0 |
| 13. | Sodium (as Na) | 19.47 | mg/ml | 19.53 | 19.51 | 19.49 | 19.48 | 19.48 |
| 14. | Vitamin A | 460 | mcg/ml | 463 | 462 | 461 | 461 | 460 |
| 15. | Vitamin D | 4.3 mcg/100 ml | | 4.35 | 4.33 | 4.32 | 4.32 | 4.31 |
| 16. | Coliform | <1 | cfu/ml | Absent | — | — | — | Absent |
| 17. | Yeast & | <1 | cfu/ml | Absent | — | — | — | Absent |
| | Mold Count | | | | | | | |

TABLE 5
Accelerated Stability data of Prorush - Orange
Volume: 180 ml
Mfg. Date: Jul. 12, 2017 Expiry Date: Aug. 11, 2018
Temperature: 40° C. ± 2° C. Stability start on Date: Aug. 12, 2017

| Sr. | | | | RESULT | Result | Result |
|---|---|---|---|---|---|---|
| No. | PARAMETERS | Limit | | (Initial) | (3 Months) | (6 Months) |
| Analysis Date | | | | | Aug. 2, 2018 | Aug. 5, 2018 |
| 1. | Description | Orange colored | | Complies | Complies | Complies |
| | | hazy liquid | | | | |
| 2. | pH | 4.6 ± 0.2 | | 4.68 | 4.65 | 4.64 |
| 3. | Degree Brix | 13.80 ± 0.05 | | 13.85 | 13.83 | 13.83 |
| 4. | Color | Orange color | | Complies | Complies | Complies |
| 5. | Taste | Typical Orange | | Complies | Complies | Complies |
| 6. | Odor | Typical Orange | | Complies | Complies | Complies |
| | | flavor | | | | |
| 7. | Iron (As Fe) | 4.17 mg/100 ml | | 5.48 | 5.46 | 5.44 |
| 8. | Calcium (As Ca) | 166.67 mg/100 ml | | 166.11 | 166.08 | 166.07 |
| 9. | Protein | 3.88 gm/100 ml | | 3.92 | 3.91 | 3.89 |
| 10. | Energy | 53.53 kcal/100 ml | | 53.58 | 53.56 | 53.54 |
| 11. | Carbohydrates | 14.93 gm/100 ml | | 14.96 | 14.95 | 14.94 |
| 12. | Fat | 0.05/100 ml | | 0.0 | 0.0 | 0.0 |
| 13. | Sodium (As Na) | 19.47 | mg/ml | 19.53 | 19.51 | 19.49 |
| 14. | Vitamin A | 460 | mcg/ml | 463 | 462 | 461 |
| 15. | Vitamin D | 4.3 mcg/100 ml | | 4.35 | 4.33 | 4.32 |
| 16. | Coliform | <1 | cfu/ml | — | — | Absent |
| 17. | Yeast & Mould | <1 | cfu/ml | — | — | Absent |
| | Count | | | | | |

It will be understood that the above description is intended to be illustrative and not restrictive. The embodiments will be apparent to those in the art upon reviewing the above description. The scope of the invention should therefore, be determined not with reference to the above description but should instead be determined by the appended claims along with full scope of equivalents to which such claims are entitled.

What is claimed is:

1. Plant based Protein drink enriched with real fruit juices comprising;
i. Plant Protein in an amount of 3.0 to 5.8% w/v;
ii. 12% to 14% reconstituted Fruit juices in an amount of 2.0 to 4.0% w/v;
iii. Vitamins and mineral premix in an amount of 0.15 to 0.30% w/v;
iv. Additives in an amount of 5.5 to 7.5% w/v; and
v. water;
wherein the said drink is free of lactose, gluten, preservative and allergen, free of non-GMO protein, has reduced fat content with easy digestibility and is 100% vegan.

2. The plant based protein drink enriched with real fruit juices as claimed in claim 1, wherein the protein is in the form of concentrate/Isolate/Hydrolysate consisting of 20%-35% by weight pulse-faba bean protein or 25%-35% by weight rice protein or 40%-45% by weight pea protein or mixtures thereof.

3. The plant based protein drink enriched with real fruit juices as claimed in claim 1, wherein the fruit concentrate is selected from pomegranate, strawberry, oranges, mixed berries or combinations thereof that activate the proteins in the body, increases the internal antioxidant activity and helps in removing the toxins from the cells.

4. The plant based protein drink as claimed in claim 1, wherein the vitamins in the protein drink are fat and water soluble vitamins and the minerals selected from copper, manganese, iron, calcium, sodium, potassium, phosphorous and the like or its salts.

5. The plant based protein drink as claimed in claim 1, wherein the additives are selected from acidity regulators in an amount ranging from 0.1 to 0.4% w/v; sweetening agent such as natural high intensity sweetener in an amount ranging from 0.2 to 0.4% w/v; emulsifying and/or stabilizing agents in an amount ranging from 0.01 to 0.04% w/v; buffering agent in an amount ranging from 0.05 to 0.2% w/v; sequestering agent in an amount ranging from 0.01 to 0.1% w/v; flavoring agents, colorants and the like in suitable amounts.

6. The plant based protein drink as claimed in claim 5, wherein the sweetening agent optionally comprises natural sugars in an amount from 6.0 to 7.5% w/v.

7. The plant based protein drink enriched with real fruit juices as claimed in claim 1, wherein the protein drink optionally further comprises Docosahexaenoic Acid (DHA) in an amount ranging from 0.1 to 0.2% w/v.

8. The plant based protein drink as claimed in claims 1-7, wherein the drink is enriched with pomegranate and strawberry juice, comprising;
i. plant protein in an amount of 3.0 to 4.2% w/v;
ii. 12% reconstituted pomegranate-strawberry juice in an amount of 2.0 to 2.8% w/v;
iii. vitamins and mineral premix in an amount of 0.12 to 0.16% w/v;
iv. additives in an amount of 7.0 to 7.5% w/v; and
v. water;
wherein the said drink is free of lactose, gluten, preservative and allergen, free of non-GMO protein, has reduced fat content with easy digestibility and is 100% vegan.

9. The plant based protein drink as claimed in claims 1-7, wherein the drink is enriched with orange juice comprising;
i. protein in an amount of 3.0 to 4.2% w/v;
ii. 12% reconstituted orange juice in an amount of 2.0 to 2.8% w/v;
iii. vitamins and mineral premix in an amount of 0.12 to 0.16% w/v;
iv. additives in an amount of 7.2 to 7.5% w/v; and
v. water;
wherein the said drink is free of lactose, gluten, preservative and allergen, free of non-GMO protein, has reduced fat content with easy digestibility and is 100% vegan.

10. Plant based protein in the form of concentrate/Isolate/Hydrolysate comprising 20%-35% by weight pulse-faba bean protein or 25%-35% by weight rice protein or 40%-45% by weight pea protein or mixtures thereof.

11. The plant based protein as claimed in claim 10, as a nutritional supplement together with real fruit juices.

12. The process for preparing plant based protein drink enriched with real fruit juices as claimed in any of the preceding claims 1-11, comprising;
(a) mixing plant based protein source in the form of concentrate/Isolate/Hydrolysate consisting of 20%-35% pulse-faba bean protein or 25%-35% rice protein or 40%-45% pea protein or mixtures thereof with RO water followed by addition of 12% to 14% reconstituted fruit juice, vitamins and mineral premix, additives with RO water; blending the above mix with pre-formulated sugar syrup and RO water;
(b) standardizing the above mixture, filtering through 1-2 mm strainer, sterilizing at temperature of 95±2° C. for 30-40 sec, homogenizing at 180 bar pressure and packing in ready to drink tetra packs.

13. The process as claimed in claim 12, wherein 1.0 to 2.0% of said plant based proteins consisting of 20%-35% pulse-faba bean protein or 25%-35% rice protein or 40%-45% pea protein or mixtures thereof are further mixed in step (a) to maintain the content of protein in the range of 3.2 to 5.8% w/v in the finished product.

14. The process as claimed in claim 12, wherein the step (a) optionally further comprises addition of Docosahexaenoic Acid (DHA) in an amount ranging from 0.1 to 0.2% w/v.

15. The Plant based protein drink according to any of the preceding claims, wherein the said protein drink used as a complete meal replacement of high nutritional value.
